(19) United States
(12) Patent Application Publication
(10) Pub. No.: US 2011/0125342 A1
(43) Pub. Date: May 26, 2011

(54) METHOD FOR CONFIGURATION OF A SWITCHGEAR ASSEMBLY

(75) Inventors: Gerhard Lang, Wilhelmshorst (DE); Götz Neumann, Berlin (DE)

(73) Assignee: SIEMENS AKTIENGESELLSCHAFT, München (DE)

(21) Appl. No.: 12/674,477

(22) PCT Filed: Aug. 22, 2007
(86) PCT No.: PCT/EP07/07566

§ 371 Date: Mar. 12, 2010

(51) Int. Cl. G06F 1/26

(52) U.S. Cl. 700/297

(57) ABSTRACT

A method parameterizes a switchgear assembly station of an electrical switchgear assembly and further parameterizes field devices, which are associated with the switchgear assembly station. In the method, parameters for parameterizing the switchgear assembly station and parameters for parameterizing the field devices are produced. A combined parameter set is generated, from which it is possible to extract both a station parameter set, which fixes the operation of the switchgear assembly station, and in each case one field device parameter set for each of the field devices. The combined parameter set is made available in a communications network to all field devices connected thereto, and each field device extracts the associated field device parameter set from the combined parameter set via the communications network and parameterizes it in accordance with the extracted field device parameter set.

The method relates to a method for configuration of a switchgear assembly station of an electrical switchgear assembly and for configuration of field devices, which are associated with the switchgear assembly station, in the electrical switchgear assembly, wherein, in the method, parameters are produced for configuration of the switchgear assembly station and parameters are produced for configuration of the field devices.

In the field of switchgear assembly technology, automation systems are designed in a known manner hierarchically, with one or more field devices being hierarchically subordinate to a switchgear assembly station. The purpose of the field devices is to detect information, such as measured values or measured value messages which relate to the electrical switchgear assembly, at the bay control level. Information which is relevant for operation is passed on from the field devices via a communication network to the respectively associated switchgear assembly station. The switchgear assembly station carries out the tasks between different fields, such as automation functions, station operation, archiving and/or protocol implementation in the direction of a superordinate network control level. Said components, that is to say the switchgear assembly station and the subordinate field devices, are configured in a known manner via configuration systems. These configuration systems produce parameter sets for configuration of the switchgear assembly station, as well as parameter sets for configuration of the associated field devices.

Said configuration systems normally comprise two units, specifically an input system which allows parameter input via a user interface, and a generation management system, which is intended for producing and managing loadable parameter files. At the end of a configuration process, the configuration systems each provide the parameter set for configuration of the switchgear assembly station and the parameter sets for configuration of the field devices. The parameter sets are then transmitted to the field devices and to the switchgear assembly station, in order to allow the device configuration process to be carried out there. Configuration systems of the described type are marketed, for example, by Siemens AG under the product names DIGSI/Netzwerkkonfigurator.

The invention is based on the object of specifying a method for configuration of a switchgear assembly station and for configuration of the associated field devices, which method ensures that all the relevant configurations are updated reliably when there is a change to the configuration of one or more devices in the switchgear assembly, thus always ensuring that all the field devices to be configured, as well as the switchgear assembly station, are each equipped with the up-to-date parameter set. One particular aim is to avoid individual ones of the field devices or the switchgear assembly station being operated with old parameter sets which are no longer appropriate for the updated parameter sets of the other devices.

Against the background of a method of the type mentioned initially, this object is achieved according to the invention by the characterizing features of claim 1. Advantageous refinements of the method according to the invention are specified in dependent claims.

The invention accordingly provides that a common parameter set is generated, from which both a station parameter set which defines the method of operation of the switchgear assembly station and in each case one field device parameter set can be extracted for each field device, the common parameter set is made available in a communication network to all the field devices connected thereto, and each field device extracts the associated field device parameter set from the common parameter set via the communication network, and configures itself on the basis of the extracted field device parameter set.

One major advantage of the method according to the invention is that it does not produce separate parameter sets for configuration of the switchgear assembly station and separate parameter sets for configuration of the field devices but, instead of this, a single, standard common parameter set which contains all the data required for configuration. In contrast to the already known method explained initially, the common parameter set ensures that all the devices are always operated with the up-to-date parameter set, since all the devices at all times access one and the same common parameter set. When using the method according to the invention, it is therefore impossible for devices to be able to access individual parameter sets to different standards, for whatever reasons.

A further major advantage of the method according to the invention is that the field devices can obtain their respectively associated field device parameter set by extraction from the common parameter set; this procedure means that the field devices have to use the communication network to check only those data items which are relevant for the respective device and are required for the respective configuration process; irrelevant data sets therefore need not be transmitted.

As a result of the presence of a common parameter set, it is also possible to use components in a hierarchically subordinate level for tasks of a superordinate hierarchy level. One advantageous refinement of the invention accordingly provides that the function of the switchgear assembly station is carried out by one of the field devices, or by at least two field devices jointly. Such distribution of the switchgear assembly station function between one or more field devices is advantageously possible because the common parameter set also contains all the data required for operation of the switchgear assembly station, as a result of which the field devices can also carry out the functionality of a “virtual” switchgear assembly station by appropriate extraction of the parameters by the field devices, provided that they are equipped with correspondingly suitable hardware.

The common parameter set is preferably produced by a configuration system which is connected to the communication network. By way of example, a refinement such as this makes it possible to feed the common parameter set that has been produced directly into the communication network and to make this available in real time to the field devices that are connected to the communication network and—if present—to the switchgear assembly station.

The communication network is particularly preferably operated with a peer-to-peer network architecture. This is because a peer-to-peer network architecture advantageously makes it possible to automatically initiate updating of the parameters of the field devices and of the parameters of the switchgear assembly station simultaneously, as a result of which the parameter sets are updated virtually in parallel. When parameters are updated, the switchgear assembly is therefore once again available relatively quickly for normal operation.

The common parameter set is preferably stored redundantly within the peer-to-peer network architecture, in order to avoid data loss.

The common parameter set may, for example, be stored in a central device in the switchgear assembly station within the peer-to-peer network architecture. If the common parameter set is stored in the switchgear assembly station, then the field devices can, for example, load this completely or in parts from the switchgear assembly station, can obtain their associated field device parameter set from the loaded common parameter set, and can configure themselves on the basis of the field device parameter set that has been obtained.

Alternatively, the common parameter set may also be stored in a field device within the peer-to-peer network architecture. In this refinement, the other field devices can load the common parameter set completely or in parts, can obtain the associated field device parameter set from the common parameter set which has been loaded completely or in parts, and can configure themselves on the basis of the field device parameter set that has been obtained.

It is considered to be particularly advantageous for the common parameter set not to be stored in a single component, but to be stored in a distributed form within the peer-to-peer network architecture. This is because distributed storage provides even greater security against data being stolen by unauthorized third parties; this is because, in this case, in order to steal the common parameter set it would be necessary not only to overcome the security of one of the storage devices (for example a field device or switchgear assembly station) in the peer-to-peer network architecture, but also to overcome the security in each of the storage devices involved in the storage process in the peer-to-peer network architecture.

When the common parameter set is stored in distributed form within the peer-to-peer network architecture, it is considered to be advantageous for the field devices to extract the associated field device parameter set from the common parameter set, which is stored in a distributed form, via the communication network, and to configure themselves on the basis of the extracted field device parameter set.

In order to allow the method to be carried out as cost-effectively as possible, it is also considered to be advantageous for the hardware of the field devices to be used for storage of the common parameter set, and for the distributed storage of the common parameter set to be distributed between at least two field devices within the peer-to-peer network architecture. In this refinement of the method, the field devices therefore carry out a dual function on the one hand, together with other field devices, they provide distributed storage of the common parameter set, and on the other hand they carry out the normal field device function for field devices, as was described initially.

As an alternative to a peer-to-peer network architecture, it is also possible to choose a server-client network architecture; in this refinement, the field devices will preferably load the common parameter set using server-client connections. In addition, when using a server-client network architecture, it is considered to be advantageous for the common parameter set to be stored redundantly.

Within such a server-client network architecture, the common parameter set can be stored in a central device in the switchgear assembly station, or alternatively in a field device.

The invention also relates to an arrangement having a switchgear assembly station, field devices and a configuration system for configuration of the switchgear assembly station and for configuration of the field devices.

According to the invention, an arrangement such as this provides that the configuration system is suitable for generating a common parameter set, from which both a station parameter set which defines the method of operation of the switchgear assembly station and in each case one field device parameter set can be extracted for each field device, and the respectively up-to-date common parameter set is made available in a communication network, which connects the field devices, to all the field devices, at least for extraction of their own field device parameter set.

With regard to the advantages of the arrangement according to the invention, reference should be made to the above statements relating to the method according to the invention, since the advantages of the arrangement according to the invention correspond essentially to those of the method according to the invention.

The switchgear assembly station is preferably formed jointly by one or more field devices, with the field device or field devices being suitable for extracting the station parameter set from the common parameter set.

The invention will be explained in more detail in the following text with reference to exemplary embodiments; in this case, by way of example:

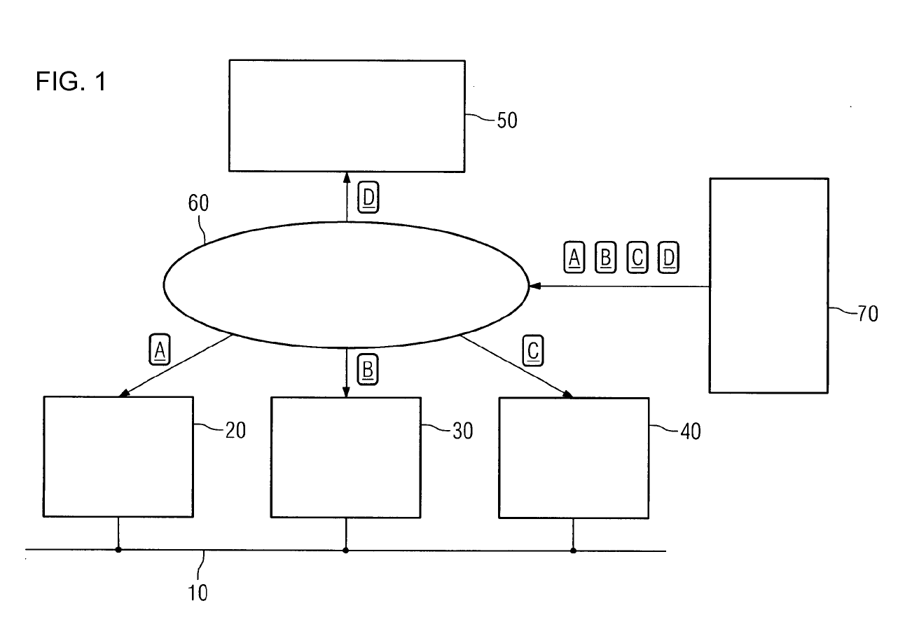

FIG. 1 shows an arrangement which is explained in order to understand the technical background better,

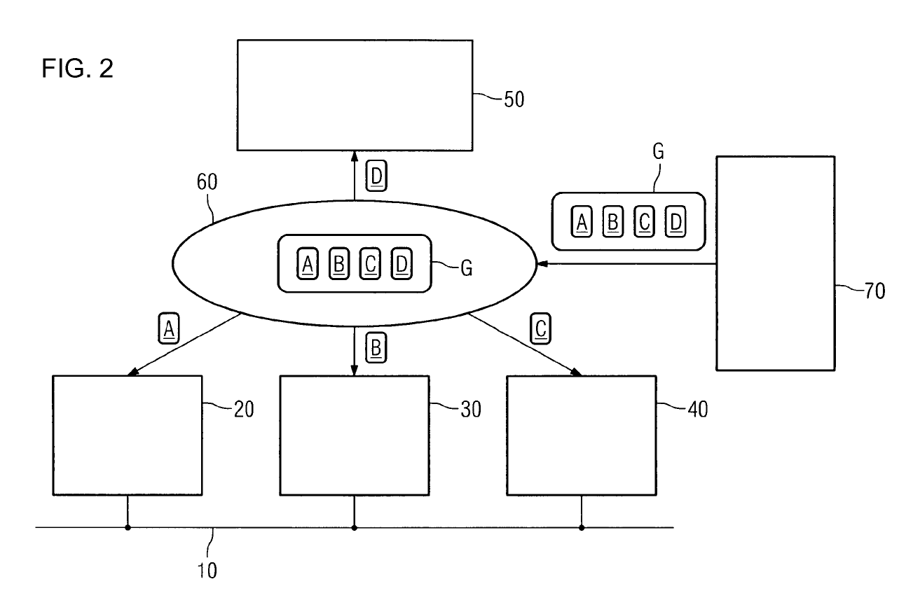

FIG. 2 shows a first exemplary embodiment of an arrangement according to the invention, which will be used as an example to explain a first exemplary embodiment of the method according to the invention,

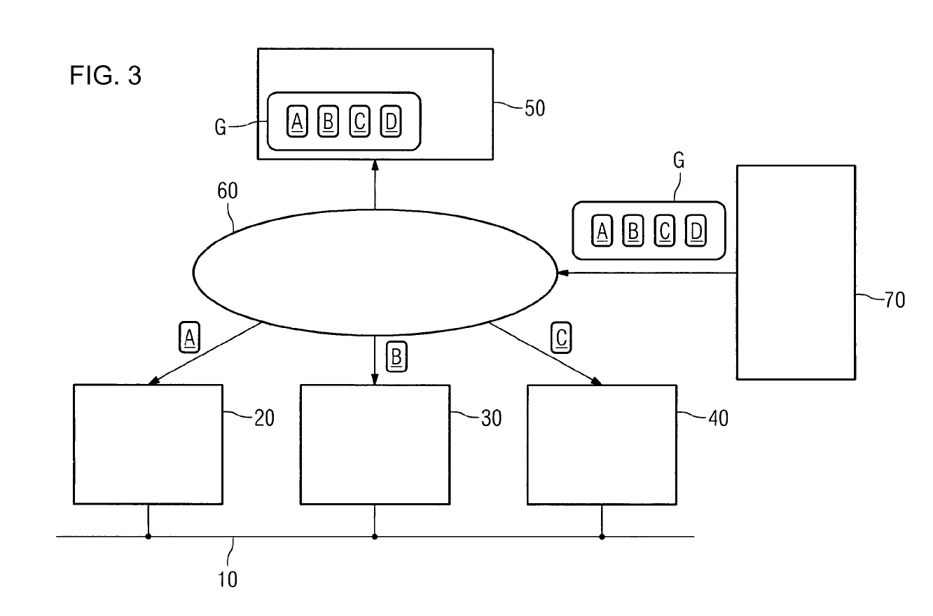

FIG. 3 shows an exemplary embodiment of an arrangement according to the invention, in which the common parameter set is stored in a switchgear assembly station,

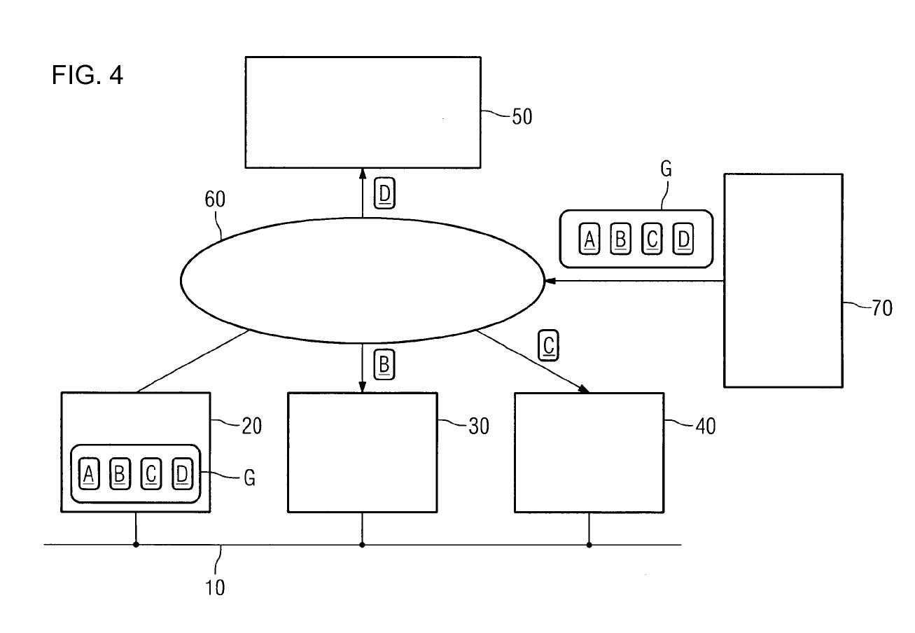

FIG. 4 shows an exemplary embodiment of an arrangement according to the invention, in which the common parameter set is stored in a field device,

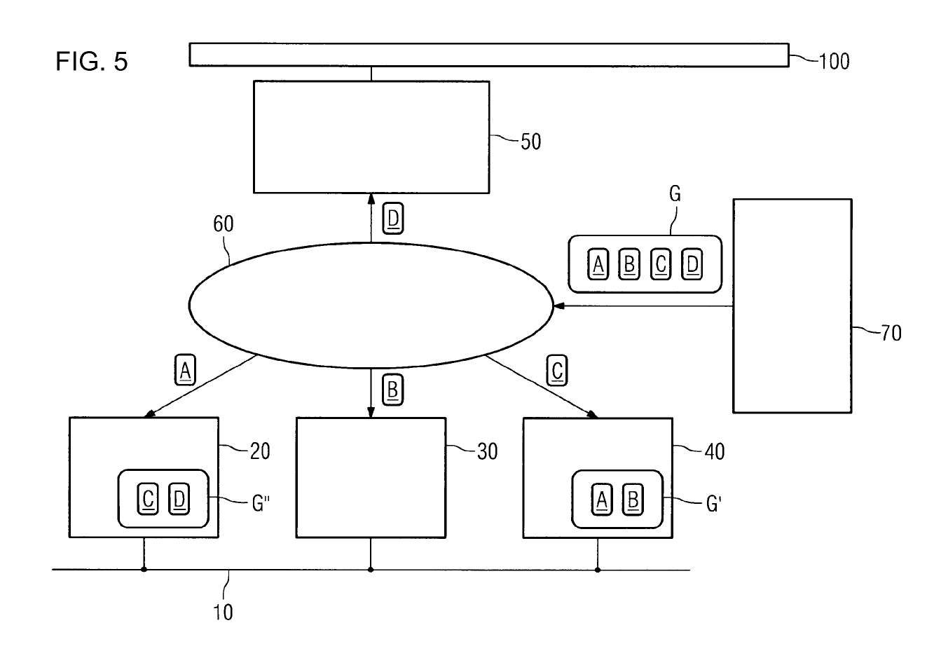

FIG. 5 shows an exemplary embodiment of an arrangement according to the invention, in which the common parameter set is stored distributed between two field devices,

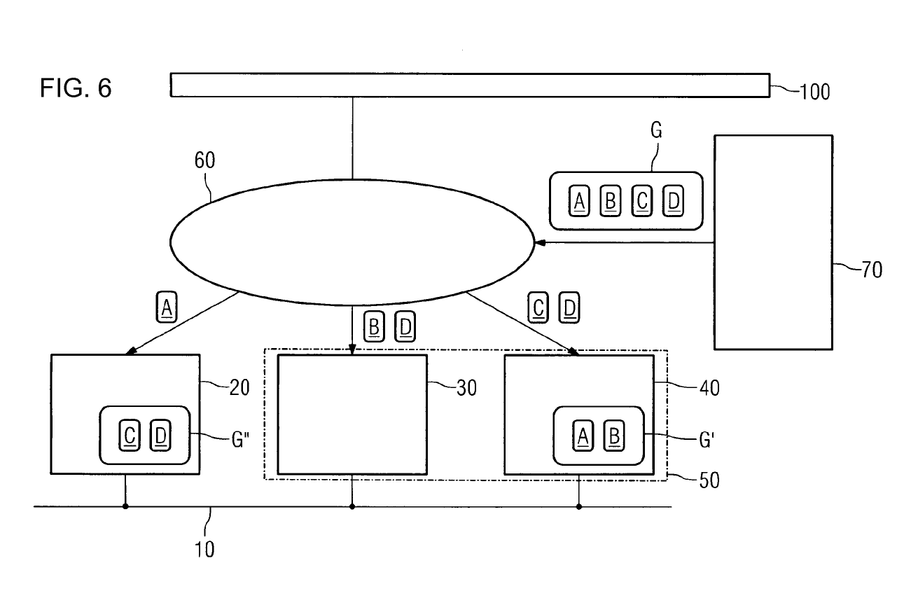

FIG. 6 shows an exemplary embodiment of an arrangement according to the invention, in which two field devices functionally simulate a switchgear assembly station, whose hardware is missing, and

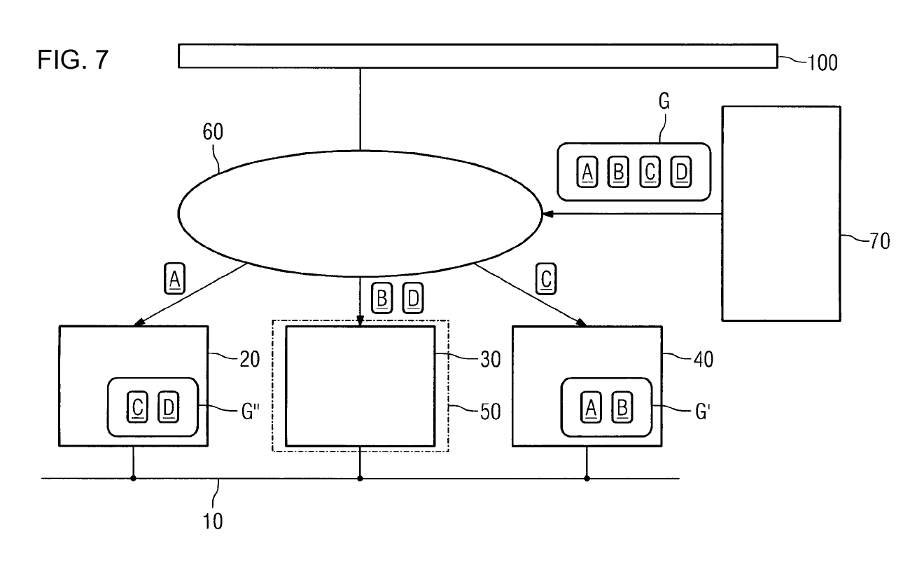

FIG. 7 shows an exemplary embodiment of an arrangement according to the invention, in which a single field device functionally simulates a switchgear assembly station whose hardware is missing.

For the sake of clarity, the same reference symbols are always used for identical or comparable components in the figures.

For general explanatory purposes, FIG. 1 shows an arrangement having an electrical switchgear assembly 10, to which three field devices 20, 30 and 40 are electrically connected. The purpose of the field devices 20, 30 and 40 is to detect and to evaluate information which relates to the electrical assembly 10. By way of example, the field devices 20, 30 and 40 may be protective devices, which disconnect parts of the electrical switchgear assembly 10 in the event of a fault.

A further purpose of the field devices 20, 30 and 40 is to pass on information that is relevant to operation to a hierarchically superordinate switchgear assembly station 50. This is done using a communication network 60, to which the field devices 20, 30 and 40 as well as the switchgear assembly station 50 are connected.

Furthermore, FIG. 1 shows a configuration system 70 which is used for configuration of the switchgear assembly station 50 and of the three field devices 20, 30 and 40. Inter alia, the configuration system 70 has an input system, which is not shown in any more detail, for a user to input parameters, as well as a generation and management system, which is used to produce parameter sets A, B, C and D for configuration of the switchgear assembly station 50 and of the field devices 20, 30 and 40.

The parameter sets for configuration of the field devices 20, and 40 are annotated with the reference symbols A, B and C, and the parameter set for configuration of the switchgear assembly station 50 is annotated with the reference symbol D.

The arrangement shown in FIG. 1 for configuration of the switchgear assembly station 50 and of the three field devices 20, 30 and 40 is, for example, operated as follows:

The configuration system 70 uses the generation and management system that has been mentioned to produce the four parameter sets A, B, C and D and to transmit them as separate files or data sets to the switchgear assembly station 50 and to the three field devices 20, 30 and 40, to be precise the parameter set D for the switchgear assembly station 50, and the parameter sets A, B and C to the three field devices 20, 30 and 40.

The configuration method shown in FIG. 1 now has the problem that there is no assurance when updating the parameter sets A, B, C and D that all the components which are connected to the electrical switchgear assembly 10 will actually always use the up-to-date parameter set, for example when one of the parameter sets A, B, C or D is not transmitted, or the transmission fails. For example, it is feasible for one of the field devices, for example the field device 20, to still be using an obsolete parameter set A even though the other devices, that is to say the two field devices 30 and 40 and the switchgear assembly station 50, are already using up-to-date parameter sets B′, C′ and D′.

FIG. 2 shows one exemplary embodiment of an arrangement according to the invention, which will be used as an example to explain the method according to the invention.

As can be seen from FIG. 2, and in contrast to the configuration system 70 shown in FIG. 1, the configuration system 70 does not produce any separate parameter sets A, B, C and D but, instead of this, a common parameter set G, from which parameter sets A, B and C for configuration of the field devices 20, 30 and 40 as well as a parameter set D for configuration of the switchgear assembly station 50 can be extracted. The configuration system 70 therefore does not produce separate files, but a single common file, which contains everything that is required for configuration of the components which are connected to the electrical switchgear assembly 10.

The common parameter set G is made available in the communication network 60, which is preferably operated with a peer-to-peer network architecture. This makes it possible for the three field devices 20, 30 and 40 as well as the switchgear assembly station 50 to extract the respectively required parameter set A, B, C or D, via the communication network 60, from the common parameter set G itself, in order to allow device configuration to be carried out.

The common parameter set G illustrated in FIG. 2 ensures that the only parameter sets which are available anywhere in the system are those which are up-to-date and are consistent, as a result of which all the components which are connected to the electrical switchgear assembly 10 can always be operated with the same up-to-date configuration.

The common parameter set G may be stored in any desired manner in the communication network 60; however, it is considered to be advantageous for a peer-to-peer functionality to be ensured.

By way of example, a peer-to-peer structure can be achieved by storing the common parameter set G in the switchgear assembly station 50, for example in a central device in the switchgear assembly station 50. An example of an embodiment such as this is illustrated in FIG. 3. In this refinement of the arrangement, the three field devices 20, 30 and 40 access the common parameter set G via the peer-to-peer communication network 60, and extract their respective parameter sets; this means that, for example, the field device 20 will extract the parameter set A, the field device 30 will extract the parameter set B, and the field device 40 will extract the parameter set C.

FIG. 4 shows another exemplary embodiment of an arrangement according to the invention, which will be used as the basis to explain, by way of example, another method variant according to the invention. In this exemplary embodiment, the common parameter set G is not stored in the switchgear assembly station 50, but in the field device 20. The other field devices 30 and 40 as well as the switchgear assembly station 50 will therefore extract their respective parameter sets from this common parameter set G: the switchgear assembly station 50 will therefore extract its parameter set D from the common parameter set G, and the two other field devices 30 and 40 will extract the parameter sets B and C from the common parameter set G.

FIG. 5 shows a further exemplary embodiment of the storage of the common parameter set G. In this exemplary embodiment, the common parameter set G is stored in a distributed form within the peer-to-peer network architecture 60 by storing a part of common parameter set G′ with individual parameter sets, for example with the parameter sets A and B for the two field devices 20 and 30, in the field device 40, and a further part of the common parameter set G″ with the two parameter sets C and D for the field device 40 and the switchgear assembly station 50 in the field device 20.

In this refinement example, the three field devices and the switchgear assembly station 50 each use the communication network 60 to access that part of the respective part of the common parameter set G′ or G″ which contains the parameter set that is relevant for it. By way of example, the field device 20 will extract the parameter set A from the part of the common parameter set G′, and will then carry out an appropriate configuration process. In a corresponding manner, the two other field devices 30 and 40 as well as the switchgear assembly station 50 will access the two parts of the common parameter set G′ and G″ in order to allow them to obtain the respectively relevant parameter set.

One advantageous aspect of the distributed storage of the common parameter set G, as shown in FIG. 5, in the communication network 60 is that none of the devices 20, 30, 40 or 50 is able to copy or to steal the complete common parameter set G. Data theft via one of said devices 20, 30, 40 and 50 is therefore completely impossible, or possible only with a very large amount of effort.

In order to make it even harder to illegally copy parts of the common parameter set G′ or G″ or the entire common parameter set G, it is also considered to be advantageous for them to be stored in a coded form; only one partial key is then preferably stored in each of the devices 20, 30, 40 and 50, allowing decryption and extraction of the device parameter set respectively required for that device, but not copying or extraction of parameter sets for other devices.

FIG. 5 also shows a network control level 100, which is hierarchically superordinate to the switchgear assembly station 50. In general, a network control level 100 may also be provided for the arrangements shown in FIGS. 1-4, even if this is not explicitly shown there.

FIG. 6 shows one exemplary embodiment of an arrangement according to the invention, in which a switchgear assembly station 50 has no hardware and is functionally replaced by the field devices 30 and 40. For this purpose, the field devices 30 and 40 also extract the parameter set D, in order to allow them to jointly simulate the functionality of the switchgear assembly station 50.

FIG. 7 shows one exemplary embodiment of an arrangement according to the invention in which the switchgear assembly station 50 is functionally simulated solely by the field device 30.

1-17. (canceled)

18. A method for configuring a switchgear assembly station of an electrical switchgear assembly and for configuring field devices associated with the switchgear assembly station, and being part of the electrical switchgear assembly, which comprises the steps of:
producing parameters for configuring the switchgear assembly station and producing parameters for configuring the field devices by the further steps of:
generating a common parameter set, from which both a station parameter set defining a method of operation of the switchgear assembly station and in each case one field device parameter set can be extracted for each of the field devices;
making the common parameter set available in a communication network to all the field devices connected thereto; and
each of the field devices extracts an associated field device parameter set from the common parameter set via the communication network, and configures itself on a basis of the field device parameter set extracted.

19. The method according to claim 18, which further comprises carrying out a function of the switchgear assembly station by one of the field devices.

20. The method according to claim 18, which further comprises producing the common parameter set by a configuration system which is connected to the communication network.

21. The method according to claim 18, which further comprises operating the communication network with a peer-to-peer network architecture.

22. The method according to claim 21, which further comprises storing the common parameter set redundantly within the peer-to-peer network architecture.

23. The method according to claim 21, which further comprises storing the common parameter set within the peer-to-peer network architecture in the switchgear assembly station.

24. The method according to claim 23, wherein each of the field devices one of entirely and partially loads the common parameter set, extracts the associated field device parameter set from the common parameter set, and configures itself on a basis of the field device parameter set extracted.

25. The method according to claim 21, which further comprises storing the common parameter set within the peer-to-peer network architecture in one of the field devices.

26. The method according to claim 25, wherein other ones of the field devices one of entirely and partially load the common parameter set, extract the associated field device parameter set from the common parameter set, and configure themselves on the basis of the field device parameter set extracted.

27. The method according to claim 21, which further comprises storing the common parameter set in a distributed form within the peer-to-peer network architecture.

28. The method according to claim 27, which further comprises extracting, via the field devices, the associated field device parameter set from the common parameter set, which is stored in a distributed form, via the communication network, and configure themselves on the basis of the field device parameter set extracted.

29. The method according to claim 27, which further comprises storing the common parameter set in a distributed form in at least two field devices.

30. The method according to claim 18, which further comprises operating the communication network with a server-client network architecture, and the field devices load the common parameter set using server-client connections.

31. The method according to claim 30, which further comprises storing the common parameter set redundantly within the server-client network architecture.

32. The method according to claim 30, which further comprises storing the common parameter set within one of the server-client network architecture in the switchgear assembly station and in one of the field devices.

33. The method according to claim 18, which further comprises carrying out a function of the switchgear assembly station by at least two of the field devices jointly.

34. A configuration, comprising:
a switchgear assembly station;
field devices;
a communication network connected to said field devices and said switchgear assembly station; and
a configuration system for configuring said switchgear assembly station and for configuring said field devices, said configuration system being suitable for generating a common parameter set, from which both a station parameter set defining a method of operation of said switchgear assembly station and in each case one field device parameter set can be extracted for each of said field devices, and the common parameter set is made available in said communication network, which connects said field devices, to all said field devices, at least for extraction of the field device parameter set.

35. The configuration according to claim 34, wherein said switchgear assembly station is formed jointly by at least one of said field devices, with said at least one field device being suitable for extracting the station parameter set from the common parameter set.
